(19) United States
(12) Patent Application Publication
(10) Pub. No.: US 2026/0225428 A1
(43) Pub. Date: Aug. 6, 2026

(54) REFRIGERANT CHARGE DIAGNOSTIC PROCEDURE FOR VEHICLE HEAT PUMP SYSTEMS

(71) Applicant: Ford Global Technologies, LLC, Dearborn, MI (US)

(72) Inventor: Scott Thomas Vehige, Woodhaven, MI (US)

(73) Assignee: Ford Global Technologies, LLC, Dearborn, MI (US)

(21) Appl. No.: 19/043,884

(22) Filed: Feb. 3, 2025

(51) Int. Cl. B60H 1/00

(52) U.S. Cl. CPC B60H 1/00978; B60H 1/00585

(57) ABSTRACT

A diagnostic for heat pumps includes heating refrigerant in a refrigerant loop of the heat pump. The temperature and pressure of the heated refrigerant may be measured, and the measured pressure and temperature may be compared to pressures and temperatures for systems that are properly charged with refrigerant to determine if the heat pump system is properly charged.

### FIELD OF THE DISCLOSURE

The present disclosure generally relates to heat pumps, and more specifically to a diagnostic procedure to determine if the heat pump system has a proper refrigerant charge.

### BACKGROUND OF THE DISCLOSURE

Heat pump systems have been used in motor vehicles and the like. Proper operation of a heat pump system may require that the system is properly charged with a refrigerant.

### SUMMARY OF THE DISCLOSURE

An aspect of the present disclosure is a method of determining refrigerant charge in vehicle heat pump systems having a heat exchanger that thermally couples a coolant loop to a refrigerant loop having an electrically powered compressor motor that drives a compressor pump. The method includes heating refrigerant in the refrigerant loop of the heat pump system. The temperature and pressure of heated refrigerant in the refrigerant loop is measured, and measured temperature and pressure of the heated refrigerant is compared to expected temperature and pressure to determine if the refrigerant charge satisfies predefined charge criteria.

Embodiments of the first aspect of the present disclosure can include any one or a combination of the following features:
Heating the refrigerant may include actuating an electric heater to heat refrigerant flowing through the electric heater.
Heating the refrigerant may include supplying electrical power to the compressor motor in a manner that causes the compressor motor to generate heat that heats refrigerant without rotation of the compressor pump.
The expected temperature and pressure may comprise a plurality of temperatures and corresponding pressures.
The heat pump system may include a coolant-cooled condenser that is configured

to exchange heat between the coolant in the coolant loop and refrigerant in the refrigerant loop. The refrigerant loop may further include: 1) an expansion valve, 2) an outside heat exchanger, and: 3) a pressure sensor. When the compressor is actuated, compressed refrigerant exits an outlet of the compressor and flows through the coolant-cooled condenser, through the expansion valve, through the outside heat exchanger, and past the pressure sensor before flowing into an inlet of the compressor. The method may include measuring pressure of the refrigerant using the pressure sensor.
Predefined diagnostic criteria may be utilized to determine if a refrigerant charge level needs to be measured prior to operation of the heat pump.
The predefined diagnostic criteria may comprise at least one factor selected from the group consisting of: low refrigerant pressure measured during a previous vehicle drive cycle, a battery reset, and an elapsed time since a prior determination of refrigerant charge in the vehicle.
The method may optionally include disabling the compressor if the refrigerant charge does not satisfy predefined charge criteria.
The method may optionally include setting a code if the refrigerant charge does not satisfy predefined charge criteria.
The method may optionally include not setting the code if the refrigerant charge satisfies predefined charge criteria.
The expected temperature and pressure optionally correspond to temperature and pressure for a fully charged heat pump system.

Another aspect of the present disclosure is a vehicle including a powered drive system, a body, and a heat pump system that is configured to heat a cabin of the vehicle. The heat pump system includes a first heat exchanger that thermally couples a coolant loop of the heat pump system to a refrigerant loop of the heat pump system. The refrigerant loop includes a compressor that is fluidly coupled to the first heat exchanger, an expansion valve, and an outside heat exchanger. The compressor includes an electrically powered compressor motor that drives a compressor pump. The vehicle includes a controller that is configured to actuate a heater to heat refrigerant, and/or cause electrical power to be supplied to the compressor motor in a manner that causes the compressor motor to generate heat and heat refrigerant without rotation of the compressor pump. The controller is further configured to compare measured temperature and pressure of the heated refrigerant to expected refrigerant temperature and pressure for a fully charged heat pump system to determine if the refrigerant charge satisfies predefined charge criteria.

Embodiments of the second aspect of the present disclosure can include any one or a combination of the following features:
The expected temperature and pressure may comprise a table including a plurality of temperatures and corresponding pressures.
The controller may be configured to: 1) prevent operation of the refrigerant loop if the refrigerant charge does not satisfy the predefined charge criteria, and 2): permit operation of the refrigerant loop if the refrigerant charge satisfies the predefined charge criteria.
The vehicle may include an electrical heater that is configured to heat refrigerant in the refrigerant loop without first heating coolant in the coolant loop.
The predefined charge criteria may comprise at least one temperature and pressure measured at the same time, wherein the at least one measured temperature and pressure are within predefined ranges of expected temperature and pressure.

Another aspect of the present disclosure is a method of diagnosing a refrigerant charge of a vehicle heat pump system having a heat exchanger that thermally couples a coolant loop to a refrigerant loop. The method includes heating refrigerant in the refrigerant loop while a pump of a compressor of the refrigerant loop is not rotating. Changes in temperature and pressure of the refrigerant that result from heating the refrigerant are measured. Changes in the measured temperature and pressure of the refrigerant are compared to expected changes in temperature and pressure to determine if the heat pump system is properly charged with refrigerant.
The method optionally includes determining that the heat pump system is properly charged with refrigerant if the changes in the measured temperature and pressure of the refrigerant are within predefined threshold ranges about expected changes in temperature and pressure for a fully charged heat pump system.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a schematic view of a vehicle including a heat pump system according to an aspect of the present disclosure;

FIG. 2 is a schematic view of a heat pump system according to an aspect of the present disclosure;

FIG. 2A is a cross sectional view of a compressor motor and pump according to an aspect of the present disclosure;

FIG. 3 is a flow chart showing a diagnostic procedure for vehicle heat pump systems; and

FIG. 4 is a flow chart showing a diagnostic procedure for vehicle heat pump systems according to another aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

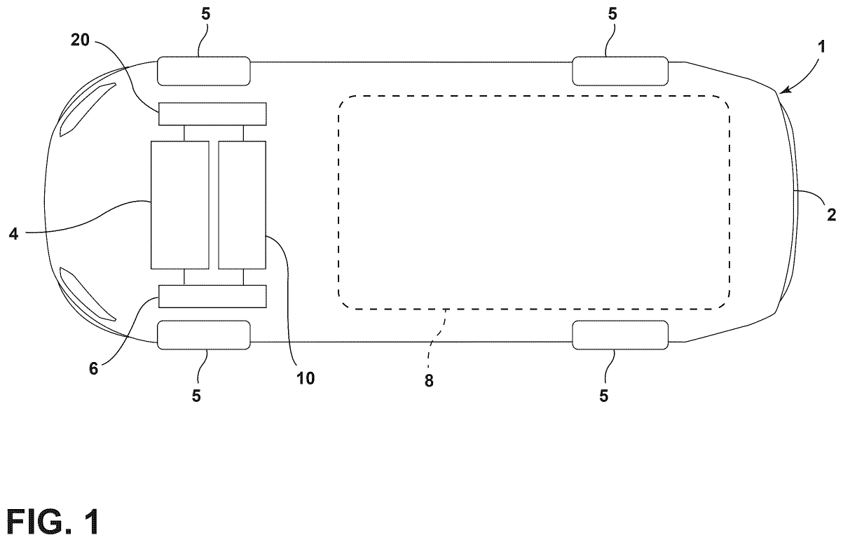

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle heat pump system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the terms “or” and “and/or,” when used in a list of two or more items, means that any one of the listed items can be employed by itself, or any combination of two or more of the listed items can be employed. For example, if a composition or device is described as containing or comprising components A, B, and/or C, the composition or device can contain (include) A alone; B alone; C alone; A and B in combination; A and C in combination; B and C in combination; or A, B, and C in combination. If a composition or device is described as containing or comprising components A and/or B and/or C, the composition or device can contain (include) A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element preceded by “comprises . . . a” or “includes . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a motor vehicle 1 according to an aspect of the present disclosure may include a body 2 and a passenger space 8. The vehicle 1 may include a power drive system 4 that drives one or more wheels 5 to move the vehicle 1. The power drive system 4 may comprise an internal combustion engine, one or more electric motors, or a combination of the two. It will be understood that the present disclosure is not limited to any particular power drive system. Vehicle 1 further includes a heat pump system 10 that may be configured to heat passenger space 8 and/or other components of motor vehicle 1.

Vehicle 1 may include a controller 6 that may be operably connected to power drive system 4, heat pump system 10, and other components of motor vehicle 1. Motor vehicle 1 may also include an electrical power source 20. The electrical power source 20 may comprise one or more batteries, alternators, and/or other components of an electrical system of motor vehicle 1. For example, if power drive system 4 comprises an electric motor, electrical power source 20 may comprise a high voltage (“HV”) battery that is used to power drive system 4.

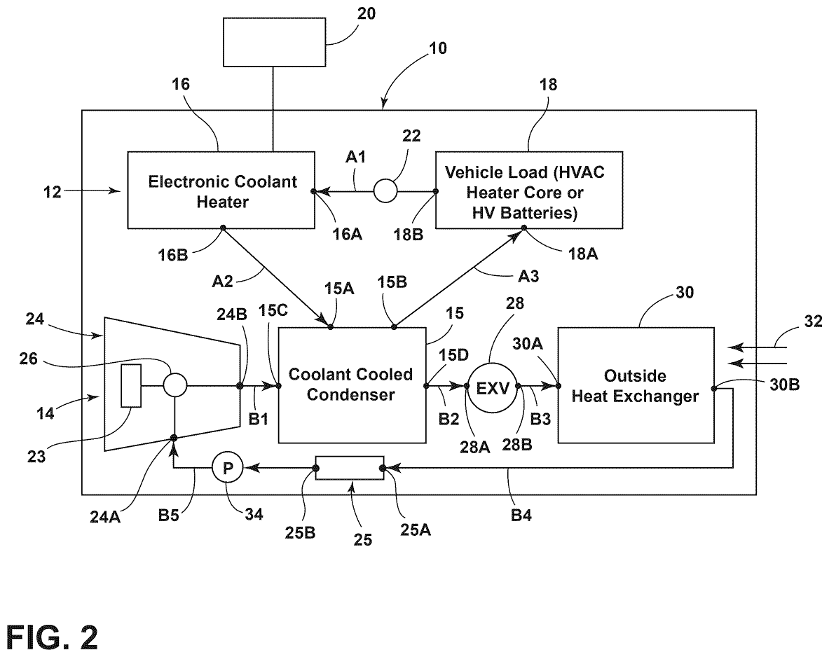

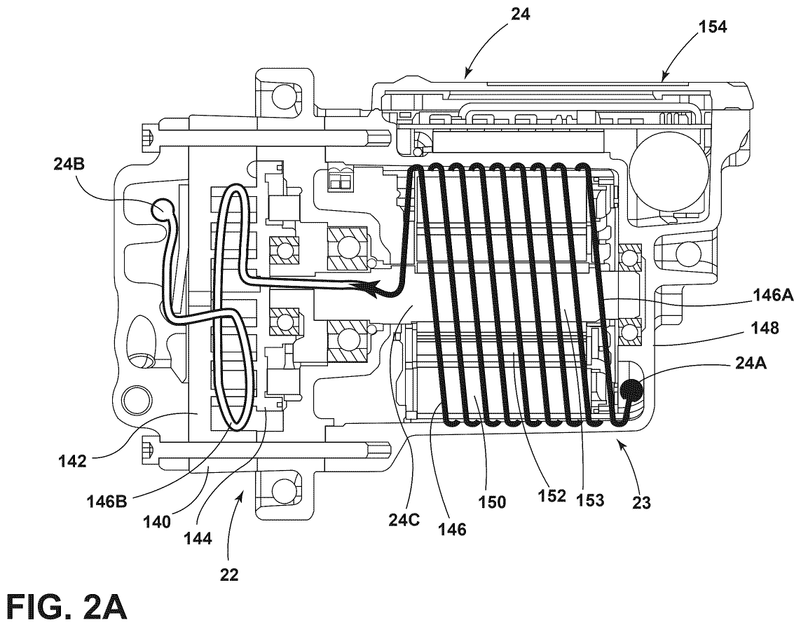

With further reference to FIG. 2, heat pump system 10 may include a coolant loop 12 that is thermally coupled to a refrigerant loop 14 by a heat exchanger 15. The coolant loop 12 may include an electronic coolant heater 16 that is operably connected to voltage source 20 whereby coolant flowing through the heater 16 can be heated upon actuation of heater 16. The coolant loop 12 further includes a vehicle thermal load 18 that receives heat. The vehicle load 18 may comprise, for example, a HVAC heater core or one or more High Voltage (“HV”) batteries (e.g. voltage source 20 may comprise a component of load 18). The coolant loop 12 may include one or more pumps 22 that circulate the coolant through the heat exchanger 15, vehicle load 18, and heater 16 as show by the arrows A1, A2, and A3. The pump or pumps 22 may be located between the heater 16 and vehicle load 18 or other suitable location. Coolant heater 16 may include a coolant inlet 16A, and a coolant outlet 16B, and heat exchanger 15 may include a coolant inlet 15A and a coolant outlet 15B. The vehicle load 18 may include a coolant inlet 18A and a coolant outlet 18B. The heat pump system 10 may include temperature and/or pressure sensors at one or more of the inlets 15A, 16A, and/or 18A, and/or one or more of the outlets 15B, 16B and/or 18B. One or more temperature and/or pressure sensors may also or alternatively be located within one or more of the heat exchanger 15 and/or heater 16 and/or vehicle load 18, or along the fluid conduits represented by the arrows A1, A2 and A3.

The refrigerant loop 14 may include a compressor 24 having an inlet 24A and an outlet 24B. During operation, an electrically powered compressor motor 23 may be actuated whereby pump 26 of compressor 24 compresses and heats refrigerant such that the heated and compressed refrigerant flows from outlet 24B to heat exchanger 15 as shown by the arrow B1. As discussed in more detail below, compressor motor 23 may comprise a multi-phase motor, and electrical power may be supplied to compressor motor 23 in a manner that causes motor 23 to generate heat that is transferred to refrigerant in refrigerant loop 14, optionally without rotating motor 23 or compressor pump 26.

During operation, refrigerant flowing through heat exchanger 15 is cooled by coolant flowing through heat exchanger 15 from the coolant loop 12, and the refrigerant then flows to an expansion valve 28 as shown by the arrow B2. Coolant then flows through from expansion valve 28 to an outside heat exchanger 30 as shown by arrow B3. Outside heat exchanger 30 may be exposed to ambient air 32. Refrigerant from outside heat exchanger 30 flows to a pressure sensor 34 as shown by the arrow B4, and refrigerant then flows to inlet 24A of compressor 24 as shown by the arrow B5. The refrigerant loop 14 may include temperature sensors at one or more inlets 15C, 28A, 30A, 24A, and may also include additional pressure sensors (i.e. in addition to pressure sensor 34) at one or more of the inlets 15C, 28A, 30A, and 24A. Similarly, one or more of the outlets 24B, 15D, 28B, and/or 30B may include a temperature sensor and/or a pressure sensor as required for a particular application. Temperature and/or pressure sensors may also be integrated into the compressor 24, heat exchanger 15 and/or outside heat exchanger 30 as required for a particular application. It will be understood that the basic operation of refrigerant loop 14 may be substantially similar to known heat pump systems of motor vehicles.

Refrigerant loop 14 may optionally include an electric heater 25 that may be actuated to heat refrigerant in refrigerant loop 14. In addition to electric heater 25, or instead of electrical heater 25, motor 23 of compressor 24 may comprise a three-phase motor that may be operated out of phase to generate additional heat that heats refrigerant in refrigerant loop 14. Temperature and/or pressure sensors may optionally be positioned at inlet 25A and/or outlet 25B of heater 25 to measure temperature and/or pressure of refrigerant entering and/or exiting heater 25. Proper operation of heat pump system 10 may require that the refrigerant level of refrigerant loop 14 be properly charged. In general, the heat pump system 10 may be operated during cold ambient conditions. As the ambient temperature drops the static pressure of refrigerant in refrigerant loop 14 also tends to drop. Known refrigerant charge detection methods may involve utilizing static pressure in a refrigerant loop to determine if the system has a proper refrigerant charge. However, if the ambient temperature is sufficiently low, this may result in a low static pressure reading. In some cases, a low static refrigerant pressure may suggest that the refrigerant level is depleted. However, the low static pressure may be due to low ambient temperatures rather than depletion of refrigerant.

With further reference to FIG. 2A, compressor pump 22 of compressor 24 may optionally comprise a scroll compressor having a frame or housing 140, a fixed scroll 142, and an orbiting scroll 144. Orbiting scroll 144 may rotate when three-phase electric motor 23 is actuated to compress refrigerant (e.g. when electric motor 23 is actuated without phase modulation that would prevent rotation of motor 23). It will be understood that numerous pumps/compressors may be utilized, and the present disclosure is not limited to the configuration of FIG. 2A.

Three-phase electric motor 23 of compressor 24 may include a housing 148, a stator 150, and a rotor 152. Rotor 152 may be rotatably supported in housing 148 by a shaft 153. The motor 23 may also include an inverter 154 that is configured to control operation of motor 23.

During operation, refrigerant flows from inlet 24A of compressor 24 along a refrigerant path 146 to outlet 24B. The refrigerant path 146 includes a first portion 146A that extends around motor 23, and a second portion 146B extending through compressor pump 22. Path 146 may comprise an inlet 24C whereby refrigerant enters compressor pump 22 at inlet 24C after the coolant exits first portion 146A of refrigerant path 146. First portion 146A of refrigerant path 146 may comprise, for example, a helical pathway formed by metal tubing or other suitable material to thereby transfer heat from the electric motor 23 to the refrigerant flowing along first portion 146A of path 146. In general, the second portion 146B of the refrigerant path may be substantially similar to the flow path of known compressor pumps.

A voltage of one or more phases of electrical power supplied to motor 23 may be modulated (reduced) to thereby cause electric motor 23 to generate additional heat relative to operation in which all three phases have equal voltages. Also, the voltage modulation may (optionally) be configured to cause motor 23 to generate heat without rotation of motor 23.

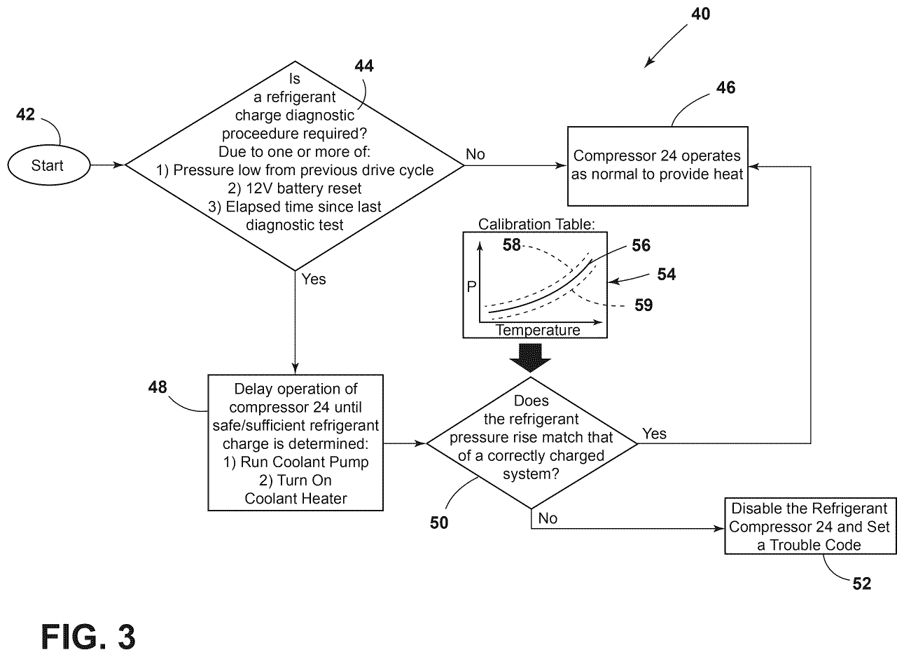

With further reference to FIG. 3, a method 40 according to an aspect of the present disclosure provides for diagnosing refrigerant charge levels in the heat pump 10 of motor vehicle 1. Method 40 may be initiated at start 42. In general, step or start 42 may occur before compressor 24 (FIG. 2) is operated to prevent damage in the event the refrigerant level is low. For example, start 42 may occur after a prior driving cycle of vehicle 1, but before a next driving cycle of the motor vehicle 1.

Following start 42, at step 44 the method 40 includes determining if a charge diagnostic procedure (steps 48 and 50) is required. The criteria for determining if a diagnostic procedure is required may include one or more of: 1) low refrigerant pressure following a previous drive cycle, 2) a 12 volt battery reset, or 3) a sufficiently long elapsed time since the last diagnostic test. As noted above, a diagnostic test according to the present disclosure may include steps 48 and 50. The low pressure criteria at step 44 may comprise a static refrigerant pressure and/or refrigerant pressure during operation, or during a prior diagnostic test. A 12 volt battery reset may comprise a change of a main vehicle battery or other event that may erase at least some memory of vehicle controller 6 or other components. Step 44 may involve determining an elapsed time since a prior diagnostic test. If the time interval is greater than a predefined maximum, the method 40 may determine that a charge diagnostic procedure is required. The time may be, for example, one day, 10 days, 30 days, 3 months, 6 months, or other suitable time interval.

If no charge diagnostic procedure is required at step 44, the heat pump system 10 (compressor 24) operates as normal as shown at step 46. However, if a charge diagnostic procedure is required, method 40 proceeds from step 44 to step 48. At step 48, operation of the compressor 24 is prevented or delayed until the system determines that a preferred operating refrigerant charge level is present. At step 48, the coolant pump 22 is actuated, and heater 16 is also actuated. This causes the coolant to be heated and circulated through the coolant loop 12 (FIG. 2) while the compressor 24 remains OFF such that refrigerant is not circulated in refrigerant loop 14.

The process 40 then proceeds to step 50. When the pump 22 and heater 16 are actuated at step 48, the temperature and pressure of refrigerant in refrigerant loop 14 typically increase as shown schematically by the calibration table 54. If the refrigerant loop 14 has a proper refrigerant charge, the temperature and pressure of the coolant may increase as shown by line 56. At step 50, the system may determine if the measured pressure and temperature of the refrigerant matches that of a properly charged system utilizing predefined criteria. The temperature and pressure may be measured at a series of time intervals and may be “time stamped” whereby measured temperature and pressure at each time are stored. For example, the “properly charged” line 56 may be utilized to determine upper and lower threshold or boundary lines 58 and 59, respectively, and the system may determine that the refrigerant pressure meets predefined criteria if the measured refrigerant pressure and temperature fall between the boundary lines 58 and 59. Line 56 may represent temperatures and pressures of refrigerant measured at a series of time intervals (e.g. every 0.1 second, every second, every 5 seconds, every 10 seconds or other suitable time interval) while coolant is heated and circulated through a coolant loop of a properly charged system while the compressor of properly charged system is deactivated. In general, the boundary lines 58 and 59 may comprise, for example, a percentage deviation (e.g. +/−1%, 2%, 5%, 10%, 20% etc.) about line 56, or a set pressure range about line 56 e.g. +/−10 p.s.i., 20 p.s.i., 30 p.s.i., 50 p.s.i., or other suitable value). However, various criteria may be utilized to determine if a measured temperature and pressure of the refrigerant satisfies predefined criteria, and the upper and the lower threshold lines 58 and 59 are merely an example of one possible criteria. Also, it will be understood that calibration table 54 may comprise a plurality of temperatures and corresponding pressures for a heat pump system that is properly charged, and the calibration data does not necessarily need to be in the form of a graph as shown in FIG. 3.

If the refrigerant pressure and temperature rise at step 50 does not satisfy predefined criteria indicative of a properly (fully) charged heat pump system, method 40 proceeds to step 52. At step 52 the compressor 24 is disabled, and a code (flag) may be set (e.g. in/by controller 6). The system may also generate a communication to a user indicating that the refrigerant charge is low, and the system needs to be recharged with refrigerant.

If the refrigerant pressure and temperature measured at step 50 satisfy the predefined charge criteria, the system proceeds to step 46, and compressor 24 may operate as normal to provide heat to passenger space 8 and/or other vehicle components if required.

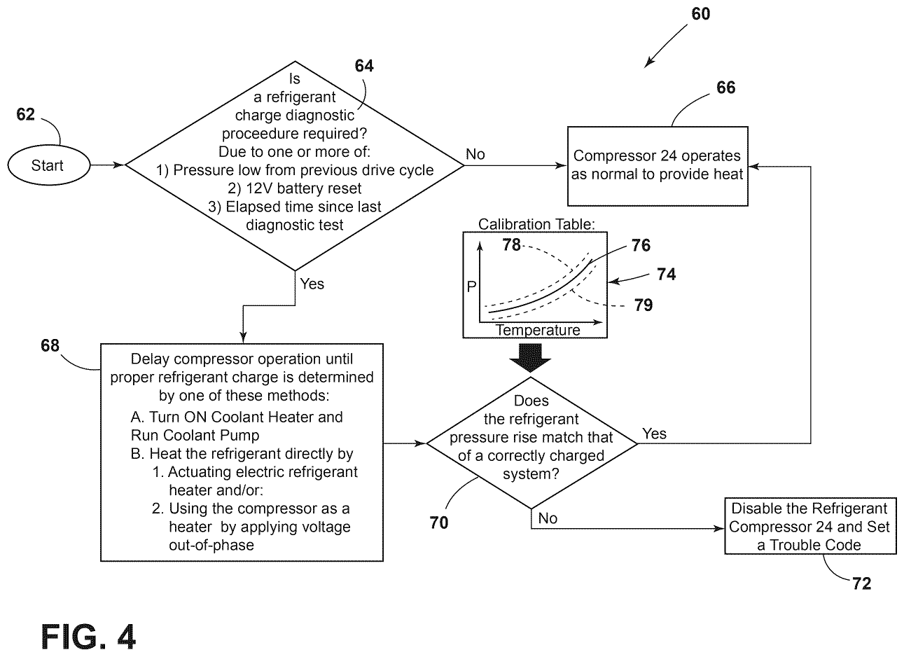

With further reference to FIG. 4, a process or method 60 according to another aspect of the present disclosure starts at step 62 and proceeds to step 64. Step 64 generally corresponds to step 44 of process 40 (FIG. 3). If a refrigerant charge diagnostic procedure is not required at step 64, operation of compressor 24 is not restricted, and the compressor 24 operates as normal to provide heat as shown at step 66. If a diagnostic procedure is required at step 64, process 60 proceeds to step 68. At step 68, compressor operation is delayed until proper refrigerant charge is determined. Proper refrigerant charge may be determined by turning on coolant heater 16 and running the coolant pump (e.g. as described above in connection with FIG. 3) or by heating the refrigerant directly by: 1) actuating electric refrigerant heater 25 and/or: 2) using compressor 24 as a heater by applying out-of-phase voltage to compressor motor 23 of compressor 24. As discussed above, the out-of-phase voltage supplied to compressor motor 23 may comprise phases in which the voltages of are not equal (e.g. the voltage at least one phase is not equal to the other two phases). In general, controller 6 (FIG. 1) may be configured to apply out-of-phase voltage to compressor motor 23, thereby causing compressor motor 23 to generate heat that is transferred to refrigerant in refrigerant loop 14. The out-of-phase electrical power may be supplied in a manner that does not result in rotation of pump 26 of compressor 24. Thus, compressor 24 may used to heat refrigerant in refrigerant loop 14 without causing refrigerant to circulate in refrigerant loop 14.

Referring again to FIG. 4, following step 68, process 60 proceeds to step 70, which includes determining if the refrigerant pressure rise matches that of a correctly charged system. This may involve use of calibration table 74. It will be understood that step 70 of process 60 generally corresponds to step 50 of process 40 (FIG. 3), and calibration table 74 generally corresponds to calibration table 54 of process 40 described above in connection with FIG. 3. In general, the calibration table 74 may include boundary lines 78 and 79 that correspond to boundary lines 58 lines and 59 as described in more detail above in connection with FIG. 3.

If the refrigerant pressure rise at step 70 matches that of a correctly charged system, process 60 returns to step 66, and compressor 24 operates as normal to provide heat. However, if the refrigerant pressure rise does not satisfy predefined charge criteria at step 70, process 60 proceeds to step 72, and compressor 24 is disabled. Step 72 may also include setting a code (flag). The system may be configured to communicate a message to a user if a code is set at step 72. The code may also be stored for diagnostic purposes (e.g. by a technician serving motor vehicle 1).

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of determining refrigerant charge in vehicle heat pump systems having a heat exchanger that thermally couples a coolant loop to a refrigerant loop having an electrically powered compressor motor that drives a compressor pump, the method comprising:
heating refrigerant in the refrigerant loop of the heat pump system;
measuring temperature and pressure of heated refrigerant in the refrigerant loop; and
comparing measured temperature and pressure of the heated refrigerant to expected temperature and pressure to determine if the refrigerant charge satisfies predefined charge criteria.

2. The method of claim 1, wherein:
heating the refrigerant includes actuating an electric heater to heat refrigerant flowing through the electric heater.

3. The method of claim 1, wherein:
heating the refrigerant includes supplying electrical power to the compressor motor in a manner that causes the compressor motor to generate heat and heat refrigerant without rotation of the compressor pump.

4. The method of claim 1, wherein:
the expected temperature and pressure comprise a plurality of temperatures and corresponding pressures.

5. The method of claim 1, wherein:
the heat pump system includes a coolant-cooled condenser that is configured to exchange heat between coolant in the coolant loop and refrigerant in the refrigerant loop;
the refrigerant loop further includes: 1) an expansion valve, 2) an outside heat exchanger, and, 3) a pressure sensor; and wherein, when the compressor is actuated, compressed refrigerant exits an outlet of the compressor and flows through the coolant-cooled condenser, through the expansion valve, through the outside heat exchanger, and past the pressure sensor before flowing into an inlet of the compressor; and including:
measuring pressure of the refrigerant using the pressure sensor.

6. The method of claim 1, including:
utilizing predefined diagnostic criteria to determine if a refrigerant charge level needs to be measured prior to operation of the heat pump.

7. The method of claim 6, wherein:
the predefined diagnostic criteria comprises at least one factor selected from the group consisting of: low refrigerant pressure from a previous vehicle drive cycle, a battery reset, and an elapsed time since a prior determination of refrigerant charge in the vehicle.

8. The method of claim 5, including:
disabling the compressor if the refrigerant charge does not satisfy predefined charge criteria.

9. The method of claim 8, including:
setting a code if the refrigerant charge does not satisfy predefined charge criteria.

10. The method of claim 8, wherein:
the code is not set if the refrigerant charge satisfies predefined charge criteria.

11. The method of claim 1, wherein:
the expected temperature and pressure correspond to temperature and pressure for a fully charged heat pump system.

12. The method of claim 11, wherein:
the expected temperature and pressure comprise a plurality of temperatures and pressures for a fully charged heat pump system.

13. The method of claim 12, wherein:
the predefined charge criteria comprises a plurality of temperatures and corresponding pressures measured at a series of times, wherein the plurality of measured temperatures and pressures are within predefined ranges about expected temperatures and pressures for a fully charged heat pump system.

14. A vehicle comprising:
a powered drive system;
a body;
a heat pump system that is configured to heat a cabin of the vehicle, the heat pump system including a first heat exchanger that thermally couples a coolant loop of the heat pump system to a refrigerant loop of the heat pump system, the refrigerant loop including a compressor that is fluidly coupled to the first heat exchanger, an expansion valve, and an outside heat exchanger, wherein the compressor includes an electrically powered compressor motor that drives a compressor pump;
a controller configured to:
actuate a heater to heat refrigerant and/or cause electrical power to be supplied to the compressor motor in a manner that causes the compressor motor to generate heat and heat refrigerant without rotation of the compressor pump; and
compare measured temperature and pressure of the heated refrigerant to expected refrigerant temperature and pressure for a fully charged heat pump system to determine if the refrigerant charge satisfies predefined charge criteria.

15. The vehicle of claim 14, wherein:
the expected temperature and pressure comprise a plurality of temperatures and corresponding pressures.

16. The vehicle of claim 14, wherein:
the controller is configured to: 1) prevent operation of the refrigerant loop if the refrigerant charge does not satisfy the predefined charge criteria, and 2): permit operation of the refrigerant loop if the refrigerant charge satisfies the predefined charge criteria.

17. The vehicle of claim 14, including:
an electrical heater that is configured to heat refrigerant in the refrigerant loop without first heating coolant in the coolant loop.

18. The vehicle of claim 14, wherein:
the predefined charge criteria comprises at least one temperature and pressure measured at the same time, wherein the at least one measured temperature and pressure are within predefined ranges of expected temperature and pressure.

19. A method of diagnosing refrigerant charge of a vehicle heat pump system having a heat exchanger that thermally couples a coolant loop to a refrigerant loop; the method comprising:
heating refrigerant in the refrigerant loop while a pump of a compressor of the refrigerant loop is not rotating;
measuring changes in temperature and pressure of the refrigerant that result from heating the refrigerant; and
comparing the changes in the measured temperature and pressure of the refrigerant to expected changes in temperature and pressure to determine if the heat pump system is properly charged with refrigerant.

20. The method of claim 19, including:
determining that the heat pump system is properly charged with refrigerant if the changes in the measured temperature and pressure of the refrigerant are within predefined threshold ranges about expected changes in temperature and pressure for a fully charged heat pump system.
